(19) United States
(12) Patent Application Publication
(10) Pub. No.: US 2008/0275895 A1
(43) Pub. Date: Nov. 6, 2008

(54) METHOD, SYSTEM, AND PROGRAM PRODUCT FOR ALIGNING MODELS

(76) Inventors: Daniel D. Leroux, Kanata (CA); Kim D. Letkeman, Nepean (CA); Duc N. Luu, Nepean (CA); Tao Weng, Kanata (CA)

Correspondence Address: HOFFMAN WARNICK LLC, 75 STATE ST, 14TH FLOOR, ALBANY, NY, 12207, US

(21) Appl. No.: 11/744,090

(22) Filed: May 3, 2007

(51) Int. Cl. G06F 17/00

(52) U.S. Cl. 707/101; 707/102; 707/E17.002

(57) ABSTRACT

The present invention provides a model identity re-alignment algorithm that allows models with similar structures but substantial identity differences to be aligned such that all similar elements have the same identity. This causes the two models to appear to have come from a common ancestor. Once the two models have been aligned with one another, it can be used as a contributor in a two or three way merge and thus, becomes a part of the normal development work flow. This allows any two models to be aligned and then participate in a normal version control work flow. It also helps eliminate massive numbers of trivial differences. It addition, it is simpler and less error prone than manual systems.

### FIELD OF THE INVENTION

The present invention generally relates to model-driven development. Specifically, the present invention relates to a model identity re-alignment algorithm.

### BACKGROUND OF THE INVENTION

Model-Driven Development typically requires that models be treated in the same way as code artifacts. Each artifact must have a life cycle, starting with creation, and proceeding through versions that are aligned with other versions of referenced model artifacts. This allows modelers to identify individual elements and to track their life cycles in perpetuity. The ability to identify individual elements is critical to supporting modeling in a team, which invariably brings parallel development into the picture. Parallel development leads to model merging, which requires that each element be distinguished from all other elements of the same type, regardless of the sameness of their names or signatures. For example, if user A and user B each add a new class “CLASS1” to a model in parallel, and user A checks the model in first, then user B is going to have to merge his or her changes back to the model to avoid overwriting all of user A's changes. This merge phase requires that the two new classes, with the same name, are easily distinguished. Under normal circumstances, this all works perfectly, because the rest of the elements all have the same identity, and thus these two new classes are both seen as additions. User B can now select which version of the class to keep when merging.

Unfortunately, problems arise when two models do not come from the same ancestor. Problems also arise when two models have gone through a significant amount of parallel change over a long time and are structurally the same, but have massive identity differences. In such situations, it is impossible for an individual to unravel the meaningful differences from superfluous identity differences. This will thwart any attempt to compare and merge these models. Examples exist of deltas across similar streams of the model same rising from 20 per model to 10,000 per model in some cases. These issues can destroy models.

### SUMMARY OF THE INVENTION

In general, the present invention provides a model identity re-alignment algorithm that allows models with similar structures but substantial identity differences to be aligned such that all similar elements have the same identity. This causes the two models to appear to have come from a common ancestor. Once the two models have been aligned with one another, it can be used as a contributor in a two or three way merge and thus, becomes a part of the normal development work flow. This allows any two models to be aligned and then participate in a normal version control work flow. It also helps eliminate massive numbers of trivial differences. It addition, it is simpler and less error prone than manual methods.

A first aspect of the invention provides a method for aligning a model, comprising: selecting a descendant model to be aligned; selecting an ancestor model to serve as a baseline set of identities; changing an identifier of the descendant model to match an identifier of the ancestor model; creating a database of matching keys with new identities by iterating the ancestor model; iterating the descendant model and generating a matching descendant key for each element of the descendant model; and searching the database for the matching descendant key for each element of the descendant model.

A second aspect of the invention provides a system for aligning a model, comprising: a selection module for selecting a descendant model to be aligned and for selecting an ancestor model to serve as a baseline set of identities; an identifier module for changing an identifier of the descendant model to match an identifier of the ancestor model; a database module for creating a database of matching keys with new identities by iterating the ancestor model; an iteration module for iterating the descendant model and generating a matching descendant key for each element of the descendant model; and a query module for searching the database for the matching descendant key for each element of the descendant model.

A third aspect of the invention provides a program product stored on a computer readable medium for aligning a model, the computer readable medium comprising program code for causing a computer system to: select a descendant model to be aligned; select an ancestor model to serve as a baseline set of identities; change an identifier of the descendant model to match an identifier of the ancestor model; create a database of matching keys with new identities by iterate the ancestor model; iterate the descendant model and generate a match descendant key for each element of the descendant model; and search the database for the match descendant key for each element of the descendant model.

A fourth aspect of the invention provides a method for deploying a system for aligning a model, comprising: providing a computer infrastructure being operable to: select a descendant model to be aligned; select an ancestor model to serve as a baseline set of identities; change an identifier of the descendant model to match an identifier of the ancestor model; create a database of matching keys with new identities by iterate the ancestor model; iterate the descendant model and generate a match descendant key for each element of the descendant model; and search the database for the match descendant key for each element of the descendant model.

A fifth aspect of the invention provides computer software embodied in a propagated signal for aligning a model, the computer software comprising instructions for causing a computer system to: select a descendant model to be aligned; select an ancestor model to serve as a baseline set of identities; change an identifier of the descendant model to match an identifier of the ancestor model; create a database of matching keys with new identities by iterate the ancestor model; iterate the descendant model and generate a match descendant key for each element of the descendant model; and search the database for the match descendant key for each element of the descendant model.

A sixth aspect of the present invention provides a data processing system for aligning a model, comprising: a memory medium comprising instructions; a bus coupled to the memory medium; and a processor coupled to the bus that when executing the instructions causes the data processing system to: select a descendant model to be aligned; select an ancestor model to serve as a baseline set of identities; change an identifier of the descendant model to match an identifier of the ancestor model; create a database of matching keys with new identities by iterate the ancestor model; iterate the descendant model and generate a match descendant key for each element of the descendant model; and search the database for the match descendant key for each element of the descendant model.

A seventh aspect of the present invention provides a method for compressing a database, comprising: compressing a database of matching keys and associated identities for elements of a model using a cyclic redundancy check (CRC).

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a method flow diagram according to the present invention.

FIG. 2 depicts a system for aligning models according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience, the detailed description of the invention has the following sections:

I. General Description

II. Computerized Implementation

### I. General Description

As indicated above, the present invention provides a model identity re-alignment algorithm that allows models with similar structures but substantial identity differences to be aligned such that all similar elements have the same identity. This causes the two models to appear to have come from a common ancestor. Once the two models have been aligned with one another, it can be used as a contributor in a two or three way merge and thus, becomes a part of the normal development work flow. This allows any two models to be aligned and then participate in a normal version control work flow. It also helps eliminate massive numbers of trivial differences. It addition, it is simpler and less error prone than manual methods.

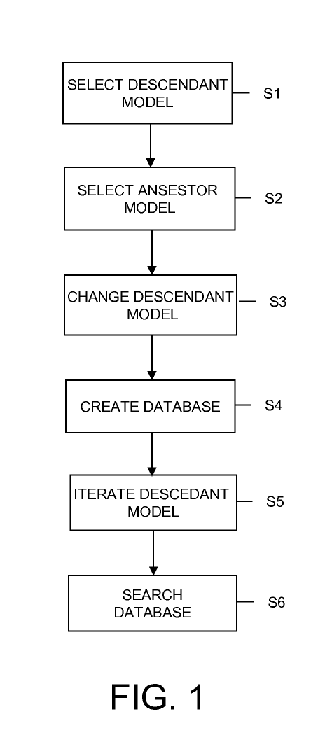

Referring now to FIG. 1, a method flow diagram according to the present invention is shown. As depicted, in step S1, a descendant model to be aligned is selected. In step S2, an ancestor model is selected to serve as a baseline set of identities. In step S3, an identifier of descendant model is changed to match an identifier of the ancestor model. In step S4, a database of matching keys with new identities is created by iterating the ancestor model. These keys are generated based on the algorithm defined below. In step S5, the descendant model is iterated and a matching key is generated for each element thereof. In step S6, the database is searched/queried for that matching key. For keys that do not exist in the database (i.e., the search/query fails to locate the matching key), a new identifier is generated for the descendant model, and a key-identifier pair is recorded/stored in the database. In addition, newly assigned identities are also added to the database for subsequent alignments of further descendant models.

As indicated above, keys are generated according to the present invention. Specifically, the algorithm is as follows: If the element has an identifier already, store that. If the element has a parent identifier, use that and add a unique identifier for this element. Along these lines, for an annotation, the present invention will use the annotation key and an index (if there is more than one annotation of a specific type). For a map, one entry per map entry will be generated, and the key will be used as the addendum to the element's identifier. For a node on a diagram, the word NODE can be used along with the identifier of the referenced element. For an edge on a diagram, the word EDGE can be used along with the identifier of the referenced relationship. For a note, the word NOTE can be used. For a geometric shape, the shape name (e.g. HEXAGON) can be used. Still yet, the present invention can append the identifiers of any other elements connected via another edge, etc.

The present invention further handles multiple models, so all steps are performed once for each model in the set of models to be aligned. Note that the model identity matching steps (S1 through S3) can be performed before running the tool on the model sets. This allows the present invention to automatically match pairs of models based on matching model identities. An additional feature is the need to allow the models to be mapped to one another if the models did not come from a common ancestor. This will cause the descendent model to take on the identifier of the ancestor model before alignment proceeds.

The present invention also allows for the database to be compressed, which is particularly useful for very large models, where the key database grows too large to efficiently process. In compressing the database, the match key itself is compressed and the CRC replaces it as the lookup key. In this case, a CRC32 or better encoding can be used as the key. This works because the lookup does not rely on the actual key content, but rather the uniqueness of the matching key.

A cyclic redundancy check (CRC) is a type of hash function, which is used to produce a small, fixed-size checksum of a larger block of data, such as a packet of network traffic or a computer file. A CRC checksum is the remainder of a binary division with no bit carry (XOR used instead of subtraction), of the message bit stream, by a predefined (short) bit stream of length n+1, which represents the coefficients of a polynomial with degree n. Before the division, n zeros are appended to the message stream. The checksum is used to detect errors after transmission or storage. A CRC is computed and appended before transmission or storage, and verified afterwards by the recipient to confirm that no changes occurred in transit. CRCs are popular because they are simple to implement in binary hardware, are easy to analyze mathematically, and are particularly good at detecting common errors caused by noise in transmission channels.

CRCs are based on division in the ring of polynomials over the finite field GF(2) (the integers modulo 2). In simpler terms, this is the set of polynomials where each coefficient is either zero or one (a single bit), and arithmetic operations wrap around (due to the nature of binary math operations). Listed below are details (polynomials and representations) of various CRC32 approaches. It should be understood that CRC is not the only approach that can be employed, under the present invention. For example, the present invention could utilize CRC16, CRC64, CRC128, CRC256, etc.

| | | |
|---|---|---|
| CRC-32- | x³² + x²⁶ + x²³ + x²² + x¹⁶ + x¹² + | 0x04C11DB7 or |
| MPEG2 | x¹¹ + x¹⁰ + x⁸ + x⁷ + x⁵ + x⁴ + | 0xEDB88320 |
| | x² + x + 1 | (0xDB710641) Also |
| | | used in IEEE 802.3 |
| CRC-32- | x³² + x²⁶ + x²³ + x²² + x¹⁶ + x¹² + | 0x04C11DB7 or |
| IEEE | x¹¹ + x¹⁰ + x⁸ + x⁷ + x⁵ + x⁴ + | 0xEDB88320 |
| 802.3 | x² + x + 1 (V.42) | (0xDB710641) |
| CRC-32C | x³² + x²⁸ + x²⁷ + x²⁶ + x²⁵ + x²³ + | |
| (Castagnoli) | x²² + x²⁰ + x¹⁹ + x¹⁸ + x¹⁴ + | |
| | x¹³ + x¹¹ + x¹⁰ + x⁹ + x⁸ + x⁶ + 1 | |

### II. Computerized Implementation

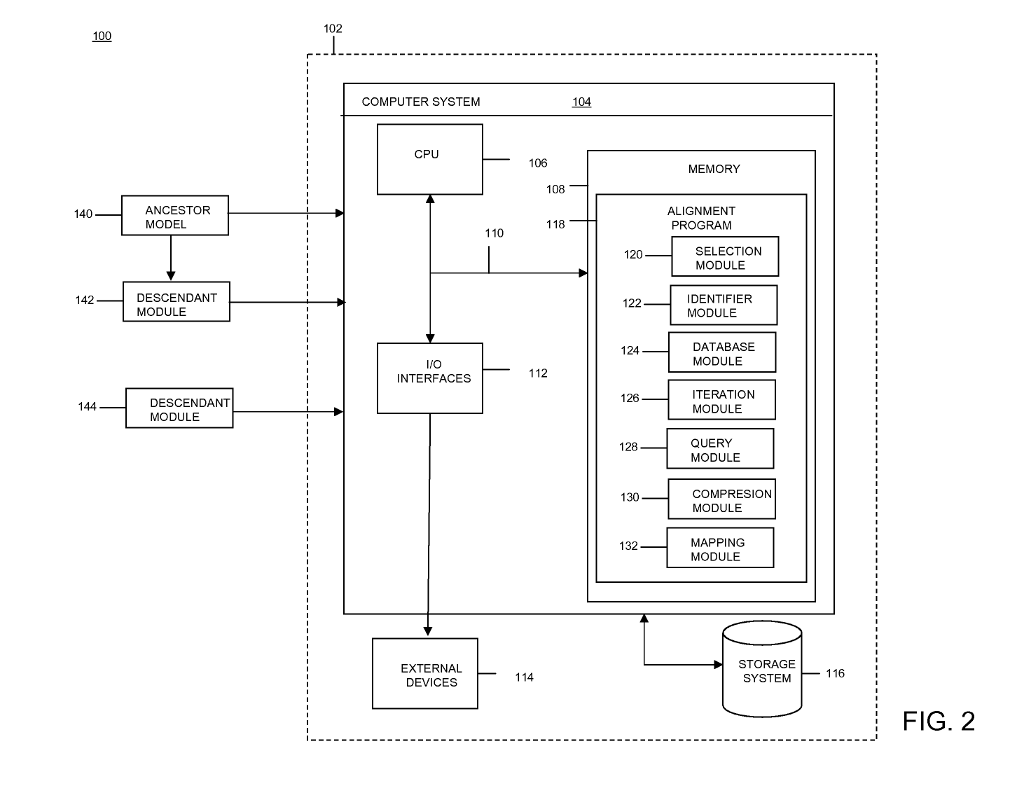

Referring now to FIG. 2, a computerized implementation 100 of the present invention is shown. As depicted, implementation 100 includes computer system 104 deployed within a computer infrastructure 102. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation 100 could be deployed, managed, serviced, etc. by a service provider who offers to implement, deploy, and/or perform the functions of the present invention for others.

As shown, computer system 104 includes a processing unit 106, a memory 108, a bus 110, and input/output (I/O) interfaces 112. Further, computer system 104 is shown in communication with external I/O devices/resources 114 and storage system 116. In general, processing unit 106 executes computer program code, such as alignment program 118, which is stored in memory 108 and/or storage system 116. While executing computer program code, processing unit 106 can read and/or write data to/from memory 108, storage system 116, and/or I/O interfaces 112. Bus 110 provides a communication link between each of the components in computer system 104. External devices 114 can comprise any devices (e.g., keyboard, pointing device, display, etc.) that enable a user to interact with computer system 104 and/or any devices (e.g., network card, modem, etc.) that enable computer system 104 to communicate with one or more other computing devices.

Computer infrastructure 102 is only illustrative of various types of computer infrastructures for implementing the invention. For example, in one embodiment, computer infrastructure 102 comprises two or more computing devices (e.g., a server cluster) that communicate over a network to perform the various process of the invention. Moreover, computer system 104 is only representative of various possible computer systems that can include numerous combinations of hardware. To this extent, in other embodiments, computer system 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 106 may comprise a single processing unit, or be distributed across one or more processing units in one or more locations, e.g., on a client and server. Similarly, memory 108 and/or storage system 116 can comprise any combination of various types of data storage and/or transmission media that reside at one or more physical locations. Further, I/O interfaces 112 can comprise any module for exchanging information with one or more external device 114. Still further, it is understood that one or more additional components (e.g., system software, math co-processing unit, etc.) not shown in FIG. 2 can be included in computer system 104. However, if computer system 104 comprises a handheld device or the like, it is understood that one or more external devices 114 (e.g., a display) and/or storage system 116 could be contained within computer system 104, not externally as shown.

Storage system 116 can be any type of system (e.g., a database such as that created in step S4 above) capable of providing storage for information under the present invention. To this extent, storage system 116 could include one or more storage devices, such as a magnetic disk drive or an optical disk drive. In another embodiment, storage system 116 includes data distributed across, for example, a local area network (LAN), wide area network (WAN) or a storage area network (SAN) (not shown). In addition, although not shown, additional components, such as cache memory, communication systems, system software, etc., may be incorporated into computer system 104.

Shown in memory 108 of computer system 104 is alignment program 118, which includes selection module 120, identifier module 122, database module 124, iteration module 126, query module 128, compression module 130, and mapping module 132. The modules generally provide the functions of the present invention as described herein. Specifically, selection module 120 selects a descendant model 142 to be aligned and selects an ancestor model 140 to serve as a baseline set of identities. Identifier module 122 changes an identifier of the descendant model 142 to match an identifier of the ancestor model 140. Database module 124 creates a database 116 of matching keys with new identities by iterating the ancestor model 140. Iteration module 126 iterates the descendant model 142 and generates a matching descendant key for each element of the descendant model 142. Query module 128 searches the database 116 for the matching descendant key for each element of the descendant model.

Further, the identifier module 122 is further adapted to: generate a new identifier for the descendent model 142 (if the search of the database 116 fails to locate a descendant matching key for an element of the descendant model 142; and record the identity with the descendant matching key in the database 116. Along these lines, the identifier module 122 is adapted to generate the new identifier by: if the element has an identifier: storing the identifier; and if the element lacks an identifier: determining if the element has a parent identifier; and adding a unique identifier to the parent identifier for the element.

As further shown in FIG. 2, a compression module 130 is provided for compressing the database 116. To this extent, compression module 130 can be adapted to compress the database 116 using a cyclic redundancy check (CRC) such as CRC16, CRC32, CRC64, CRC 128, CRC256, etc. Mapping module 132 can also be provided for mapping a second descendant model 144 to the descendant model 142, if the second descendant model 144 did not originate from the ancestor model 140. Mapping module 132 should be understood to be capable of aligning as many descendant streams as desired (e.g., to allow for cascading).

While shown and described herein as a method, system, and program product for aligning models, it is understood that the invention further provides various alternative embodiments. For example, in one embodiment, the invention provides a computer-readable/useable medium that includes computer program code to enable a computer infrastructure to align models. To this extent, the computer-readable/useable medium includes program code that implements each of the various process of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 108 (FIG. 2) and/or storage system 116 (FIG. 2) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process of the invention on a subscription, advertising, and/or fee basis. That is, a service provider, such as a Solution Integrator, could offer to align models. In this case, the service provider can create, maintain, support, etc., a computer infrastructure, such as computer infrastructure 102 (FIG. 2) that performs the process of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for aligning models. In this case, a computer infrastructure, such as computer infrastructure 102 (FIG. 2), can be provided and one or more systems for performing the process of the invention can be obtained (e.g., created, purchased, used, modified, etc.) and deployed to the computer infrastructure. To this extent, the deployment of a system can comprise one or more of: (1) installing program code on a computing device, such as computer system 104 (FIG. 2), from a computer-readable medium; (2) adding one or more computing devices to the computer infrastructure; and (3) incorporating and/or modifying one or more existing systems of the computer infrastructure to enable the computer infrastructure to perform the process of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

A data processing system suitable for storing and/or executing program code can be provided hereunder and can include at least one processor communicatively coupled, directly or indirectly, to memory element(s) through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output or I/O devices (including, but not limited to, keyboards, displays, pointing devices, etc.) can be coupled to the system either directly or through intervening I/O controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems and Ethernet cards.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method for aligning a model, comprising:
selecting a descendant model to be aligned;
selecting an ancestor model to serve as a baseline set of identities;
changing an identifier of the descendant model to match an identifier of the ancestor model;
creating a database of matching keys with new identities by iterating the ancestor model;
iterating the descendant model and generating a matching descendant key for each element of the descendant model; and
searching the database for the matching descendant key for each element of the descendant model.

2. The method of claim 1, further comprising:
if the searching fails to locate a descendant matching key for an element of the descendent model in the database:
generating a new identifier for the descendent model; and
recording the identity with the descendant matching key in the database.

3. The method of claim 2, the generating comprising:
if the element has an identifier:
storing the identifier;
if the element lacks an identifier:
determining if the element has a parent identifier; and
adding a unique identifier to the parent identifier for the element.

4. The method of claim 1, further comprising compressing the database.

5. The method of claim 4, the compressing comprising compressing the database using a cyclic redundancy check (CRC).

6. The method of claim 5, the CRC comprising CRC32.

7. The method of claim 1, further comprising mapping a second descendant model to the descendant model, if the second descendant model did not originate from the ancestor model.

8. A system for aligning a model, comprising:
a selection module for selecting a descendant model to be aligned and for selecting an ancestor model to serve as a baseline set of identities;
an identifier module for changing an identifier of the descendant model to match an identifier of the ancestor model;
a database module for creating a database of matching keys with new identities by iterating the ancestor model;
an iteration module for iterating the descendant model and generating a matching descendant key for each element of the descendant model; and
a query module for searching the database for the matching descendant key for each element of the descendant model.

9. The system of claim 8, the identifier module being further adapted to:
generate a new identifier for the descendent model; and
record the identity with the descendant matching key in the database.

10. The system of claim 9, the identifier module being adapted to generate the new identifier by:
if the element has an identifier:
storing the identifier;
if the element lacks an identifier:
determining if the element has a parent identifier; and
adding a unique identifier to the parent identifier for the element.

11. The system of claim 8, further comprising a compression module for compressing the database.

12. The system of claim 11, the compression module being adapted to compress the database using a cyclic redundancy check (CRC).

13. The system of claim 12, the CRC comprising CRC32.

14. The system of claim 8, further comprising a mapping module for mapping a second descendant model to the descendant model, if the second descendant model did not originate from the ancestor model.

15. A program product stored on a computer readable medium for aligning a model, the computer readable medium comprising program code for causing a computer system to:
select a descendant model to be aligned;
select an ancestor model to serve as a baseline set of identities;
change an identifier of the descendant model to match an identifier of the ancestor model;
create a database of matching keys with new identities by iterate the ancestor model;
iterate the descendant model and generate a match descendant key for each element of the descendant model; and
search the database for the match descendant key for each element of the descendant model.

16. The program product of claim 15, the computer readable medium comprising program code for causing the computer system to:
if the search fails to locate a descendant match key for an element of the descendent model in the database:
generate a new identifier for the descendent model; and
record the identity with the descendant match key in the database.

17. The program product of claim 16, the computer readable medium comprising program code for causing the computer system to:
if the element has an identifier:
store the identifier;
if the element lacks an identifier:
determine if the element has a parent identifier; and
add a unique identifier to the parent identifier for the element.

18. The program product of claim 15, further the computer readable medium comprising program code for causing the computer system to compress the database.

19. The program product of claim 18, the computer readable medium comprising program code for causing the computer system compress the database us a cyclic redundancy check (CRC).

20. The program product of claim 19, the CRC comprising CRC32.

21. The program product of claim 15, the computer readable medium comprising program code for causing the computer system map a second descendant model to the descendant model, if the second descendant model did not originate from the ancestor model.

22. A method for deploying a system for aligning a model, comprising:
providing a computer infrastructure being operable to:
select a descendant model to be aligned;
select an ancestor model to serve as a baseline set of identities;
change an identifier of the descendant model to match an identifier of the ancestor model;
create a database of matching keys with new identities by iterate the ancestor model;
iterate the descendant model and generate a match descendant key for each element of the descendant model; and
search the database for the match descendant key for each element of the descendant model.
